(19) United States
(12) Patent Application Publication
(10) Pub. No.: US 2020/0340273 A1
(43) Pub. Date: Oct. 29, 2020

(54) LOCKING MECHANISM FOR DOUBLE DOORS

(71) Applicant: Jacob Raber, Mocksville, NC (US)

(72) Inventor: Jacob Raber, Mocksville, NC (US)

(21) Appl. No.: 16/397,315

(22) Filed: Apr. 29, 2019

(51) Int. Cl. E05B 17/20; E05C 19/18

(52) U.S. Cl. CPC E05B 17/2065; E05C 19/184; E05C 19/182

(57) ABSTRACT

A locking mechanism for double doors includes a three-sided bar having a top side and a pair of vertical sides extending downwardly from the edges of the top side. Each vertical side includes a slot formed therein. An L-shaped bracket has a first section for attachment to an interior surface of a door, and a second section that extends through a slot in the door outwardly through the exterior side of the door. To lock the doors, the second portion of the bracket slides through the slots in the vertical sides of the bar. A lock hole is positioned on the second portion of the bracket, and when the three-sided bar is engaged with the bracket and the lock hole is positioned between the vertical sides of the bar, a padlock or combination lock engages the lock hole to hold the bar in place across the double doors.

### BACKGROUND OF THE INVENTION

Many types of out-buildings, such as sheds, barns, and the like are used for storing yard equipment and farm machinery, and thus require large doorways in order to allow riding lawnmowers, tractors and other large equipment to pass therethrough. Oftentimes, these large doorways include double doors, also commonly referred to as French doors.

Because the equipment that is typically stored in these types of outbuildings can be expensive, it is important to be able to lock and secure the doors to prevent thievery. There are quite a few different types of locks and securing mechanisms for double doors on the market today. Some double door assemblies are manufactured with locks pre-installed from the factory, and there are also after market locks that can be purchased separately and installed on the doors. Examples of double door locking mechanisms are set forth below, and each of these references are hereby incorporated by reference herein, in their entireties:

U.S. Pat. No. 2,536,941 Fastening Means

This invention relates to fastening means which consist of a new and useful staple and hasp combination which is particularly adapted for use in connection with the locking of doors and the like, which, because of the material of which they are made, render it impractical if not impossible to attach customary staples and hasps for locking.

U.S. Pat. No. 4,326,394 Portable Door Lock
A Portable Door Lock which is Releasably Coupled to Door Frame (12) and a door member for positionally constraining the door member to the door frame when the portable door lock is in an operational mode. The portable door lock includes a door engagement mechanism which is insertable between the door member and the door frame at the interface thereof. The door engagement mechanism matingly engages the door member on front and rear surfaces and contacts the door frame on a rear surface. A locking bar mechanism is longitudinally displaceable on the door engagement mechanism and extends across the interface of the door member and the door frame for contacting the frontal surfaces of the door frame and the door member. A lock mechanism is releasably securable to the door engagement mechanism to prevent displacement of the locking bar mechanism from the door engagement mechanism for maintaining the door frame and door member in constrained relation each to the other, in order to minimize the possibility of an unauthorized opening of door member.

U.S. Pat. No. 4,405,165 Temporary Door Locking Device

A device for demountable temporary locking of a door is configured for use in locking inwardly and outwardly opening doors from either or both the inside and the outside. The device includes a door engaging member having a collar plate removably mounted thereon for lockably mounting the door engaging member on the door, and having a slidably movable door jamb engaging member which is lockable in its door jamb engaging position.

U.S. Pat. No. 4,491,354 Lock Bar

A lock bar for securing a pair of door panels having lock and hinge edges in a locked position and indicating whether or not the panels are locked, including a pair of elongated hollow holding brackets having a rectangular cross section aligned horizontally and secured to the door panels adjacent the lock edges thereof, and an elongated, hollow, rectangular cross section, cross bolt extending horizontally through the holding brackets.

U.S. Pat. No. 4,653,786 Portable Security Lock

A portable locking system for hinged door improves on the type having a right-angle end of a first member for engaging a strike plate in a door frame and second member with a right angle end for pressing against the door and laterally and detachably engaging the first member. The detachable lateral engagement of this invention includes a series of holes tangential to each other in the first member and a plurality of juxtaposed pins protruding from the second member in position for adjustably engaging any corresponding selected holes in the first member. The system preferably includes a “U”-shaped keeper for holding the first and second members together for carrying them, or after installation. For identification in the dark and for ease in handling, a second angled-end of the hole plate is made longer than the first end. Similarly, one of the legs of the “U”-shaped keeper is made longer than the other.

U.S. Pat. No. 5,361,539 Door Securing Mechanism

A demountable door securing device includes a door edge engaging plate with a right angled bend adapted to rest against one face of the door and an extended portion terminating in a hinge on the opposite side of the door. A rotating door engaging member including a planar portion and a right angled portion can be rotated to engage a face of the door. A security bar through apertured tabs in the extended portion prevents rotation of the planar portion. The right angled bend includes an extended bar portion parallel to the door face at the free end of which a hasp is pivotally mounted. The hasp rotates into engagement with the door frame and is held in place by a securing bar extending outward from the right angled bend. A tongue on the free end of the securing bar fits through an aperture in the hasp and holes in the tongue can receive a locking device.

U.S. Pat. No. 5,547,236 Removable Door Lock

A device for temporarily locking a door which has an extension arm having one end secured perpendicularly to a channel straddling an edge of the door and extending away from the channel and a retainer arm telescoped onto the retainer arm that can be oriented either vertically or horizontally for engagement with the wall so that the locking device can be positioned at any location on either the top or vertical unhinged edge of the door. A bar may also be attached to the retaining arm when the retaining arm is oriented in the horizontal position. The means for securing the device to the door is also provided with an adjustable spacer means for attachment to a door having one of a range of thicknesses.

U.S. Pat. No. 5,669,641 Door Securing System

A door securing system including a pivot anchor; a latch anchor; a telescoping cross-bar having a pivot section that is slidingly and rotatably received within a tubular latch section; and an adjustable door contact assembly including a contact securing mechanism securable to and positionable along at least a securing section of the latch section and a user positionable bumper plate that is positionable in a plurality of user selected distances away from the latch section. In use, the cross-bar is held in place across the door to be secured by the pivot anchor and the latch anchor and the bumper plate locked into contact with the door surface to prevent opening of the door.

U.S. Pat. No. 5,810,404 Portable Door Lock

A portable door lock for use in holding closed a door that swings on hinges from an open position to a closed position wherein an edge of the door, opposite its hinged edge, is adjacent to a closure surface with a clearance gap therebetween. The portable door lock comprises a strap secured at one end to an anchor and to an opposite end to a locking member. The strap is positioned with the clearance gap such that the anchor abuts one side of the hinged door and one side of the closure surface. Simultaneously, the locking member is adjustably coupled to the strap at a particular point such that the locking member abuts an opposite side of the hinged door and an opposite side of the closure surface. In such a configuration, the door is held from motion with respect to the adjacent closure surface.

U.S. Pat. No. 7,344,167 Door Security Apparatus

A door security apparatus and method that is adapted to assist in retaining a pair of adjacent doors in a closed state, thereby to help protect against unauthorized opening of the doors by placing the doors into an open state. The door security apparatus includes a channeled extension beam having a longitudinal axis, the beam is adapted to fit over and removably engage a pair of adjacent door edges that are in the closed state and a mechanism for manually selectively rotatably clamping or unclamping the beam to at least one door edge. Wherein the doors have increased protection against unauthorized opening, thus placing the doors into a more secured closed state, the mechanism only manually selectively clamping or unclamping the beam from the door edge by applying a manual external force in conjunction with manual forward or manual reverse rotation.

U.S. Pat. No. 8,851,535 Security Device for a Double Door

A security device for a double door, including a first locking portion having a curved portion and an elongated male portion, and a second locking portion having a curved portion and an elongated female portion. A lock mechanism includes a pair of rows of teeth having a gap therebetween and associated with the bottom side of the male portion and a locking prong mounted to the female portion. The locking prong has a flexible finger portion that terminates in a T-shaped end. The finger portion can slide between the gap in the rows of teeth. A release button mounted on the female portion, when pressed, causes the locking prong to bend downward, disengaging the T-shaped end from between the teeth and allowing the first and second locking portions to separate, thereby unlocking the security device.

### U.S. Patent Application No. 20110192092 Security Apparatus

A security apparatus may include a portion that engages a wall on one side of a doorway, a portion that extends through the doorway, and another portion that may engage the door on the opposite side of the doorway. In operation, the apparatus may function to transmit a force applied to the front of the door to the exterior wall to reinforce the door against an unauthorized entry (e.g., an intruder kicking the door).

### U.S. Patent Application No. 20130180294 Removable Door Locking Mechanism

This reference discloses a method of locking and unlocking a door that is equipped with an electronic lock, to be locked and unlocked with a removable mechanical lock, enabling orthodox Jews that observe the Sabbath laws to use the door on Saturdays. Also disclosed herein is how to fortify a hotel room door by adding a removable mechanical proprietary lock over the built-in electronic lock. These modifications can be done without damaging the door.

Each of the references set forth above disclose locking mechanisms for double doors, and each of these locking mechanisms has disadvantages. Thus, it would be desirable to provide a simple locking mechanism that is inexpensive to manufacture, easy to install, and prevents access through the doors by unauthorized personnel.

### BRIEF SUMMARY OF THE INVENTION

In accordance with one aspect of the invention, one embodiment of a locking mechanism includes a three-sided bar having a generally U-shaped cross section. The bar includes a top side and two parallel vertical sides extending downwardly from the longitudinal sides of the horizontal plate at a right angle. One of the vertical sides is the front side that faces outwardly from the door, and the other vertical side is the rear side that faces the door. An L-shaped bracket includes a pair of holes on a first side thereof, so that the L-shaped bracket may be installed on the inside portion of a door (preferably one of two double doors) by securing screws through the holes of the L-shaped bracket and into the door. In a preferred embodiment, the second side of the L-shaped bracket extends through a slot in the door, so that it is protruding through the external side of the door.

Each vertical side of the three-sided bar includes a slot, so that the second side of the L-shaped bracket that protrudes outwardly on the external side of the door may pass through the slots in the vertical sides of the three-sided bar. A lock hole is precisely positioned on the second side of the L-shaped bracket, so that when the bar is positioned on the second side of the L-shaped bracket, the lock hole is positioned between the vertical sides and beneath the top side of the three-sided bar. In one embodiment, a pair of spacer plates may be affixed to the rear side of the bar, so that the spacers are positioned against the bar on one side, and against the doors on the opposed side thereof. The spacers are used to provide a snug fit between the bar and the door when the locking assembly is in the locked position.

When the doors are closed, and the bar is in the secured position so that the second side of the L-shaped bracket extends through the slots of the vertical sides and the lock hole is properly positioned between the vertical sides of the bar, then a lock may be placed through the lock hole and secured into the locked position. While the locking assembly is in the locked position, the spacers are preferably in contact with both doors on one side thereof, and are attached to the rear side of the bar by screws, bolts, or the like.

### BRIEF DESCRIPTION OF THE DRAWINGS

These and other features, aspects, and advantages of the present invention will become better understood with regard to the following description, appended claims, and accompanying drawings where:

FIG. 1 is a front view of one embodiment of the present invention, showing a barn having a pair of double doors, wherein one of the doors is secured to the frame by top and bottom sliding lock mechanisms, and further showing the present locking mechanism extending between both doors on an outside portion thereof;

FIG. 1A is a front view of one embodiment of the present invention, showing a barn having a single door, and further showing the present locking mechanism having the three-sided bar extending in front of both the door and the door frame in a secured position;

FIG. 2 is a perspective view of one embodiment of the present locking mechanism, showing an L-shaped bracket that is adapted to be secured to an inner portion of a door or door frame on a first portion thereof, and further showing the three-sided bar that is positioned on a second portion of the L-shaped bracket, wherein spacer plates are affixed to a rear side of the three-sided bar, and further showing a lock that may be used to secure the three-sided bar to the second portion of the L-shaped bracket;

FIG. 3 is a perspective cutaway view of one embodiment of the present locking mechanism attached between a pair of double doors, showing the lock positioned within the lock hole for securing the three-sided bar to the second portion of the L-shaped bracket;

FIG. 4 is a side cross-sectional view of one embodiment of the present locking mechanism, showing the L-shaped bracket attached to a door and a lock positioned within the lock hole for securing the three-sided bar to the second portion of the L-shaped bracket;

FIG. 5 is a top cross-sectional cutaway view of the embodiment of the present locking mechanism shown in FIG. 3, wherein a lock is positioned within the lock hole for securing the three-sided bar to the second portion of the L-shaped bracket;

FIG. 6 is a top cross-sectional view of another embodiment of the present locking mechanism, wherein the three-sided bar is bolted to a first door on one side, and the bracket is attached to the opposed door or door frame;

FIG. 7 is a side cross-sectional view of one embodiment of the present locking mechanism, showing the L-shaped bracket attached to a door frame and a lock positioned within the lock hole for securing the three-sided bar to the second portion of the L-shaped bracket;

FIG. 8 is a top cross-sectional cutaway view of another embodiment of the present locking mechanism, wherein the L-shaped bracket is attached to a door frame, and the second portion of the L-shaped bracket extends through a slot in the door frame for engagement to the three-sided bar, and wherein the spacer plates on either side of the three-sided bar have the same thickness; and

FIG. 9 is a top cross-sectional view of another embodiment of the present locking mechanism, wherein the L-shaped bracket is attached to a door frame, and the second portion of the L-shaped bracket extends through a slot in the door frame for engagement to the three-sided bar, and wherein the spacer plates on either side of the three-sided bar have different thicknesses;

### DETAILED DESCRIPTION OF THE INVENTION

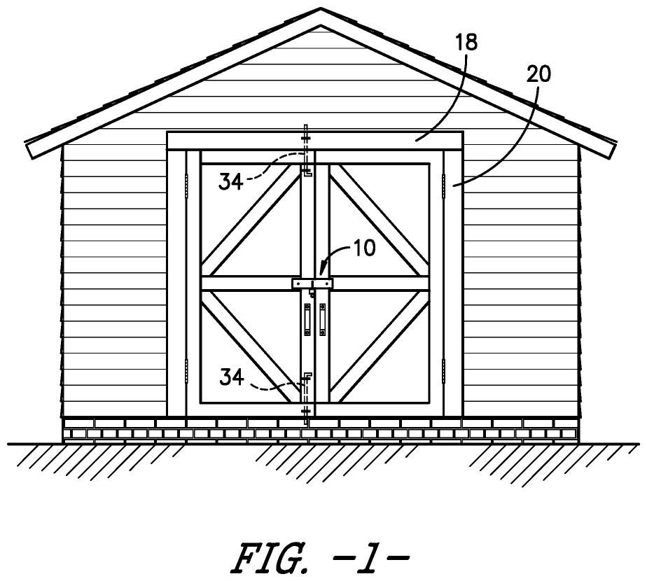

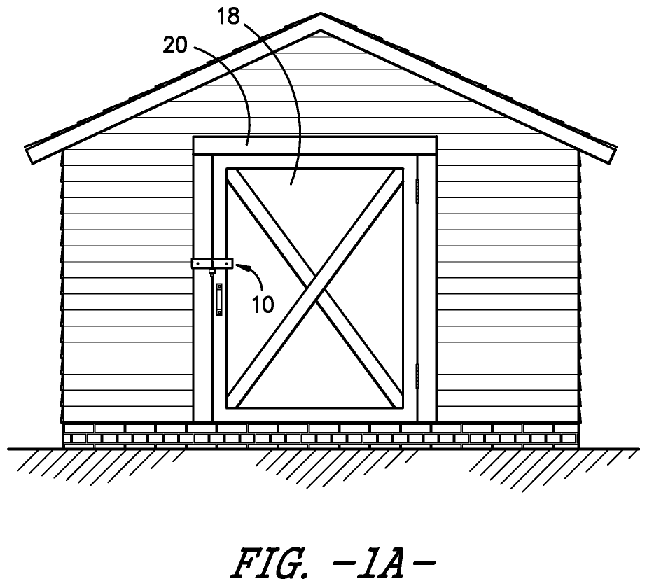

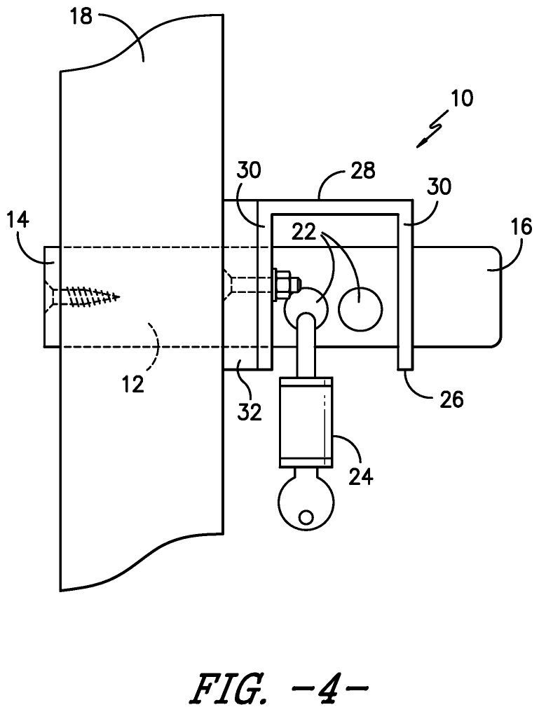

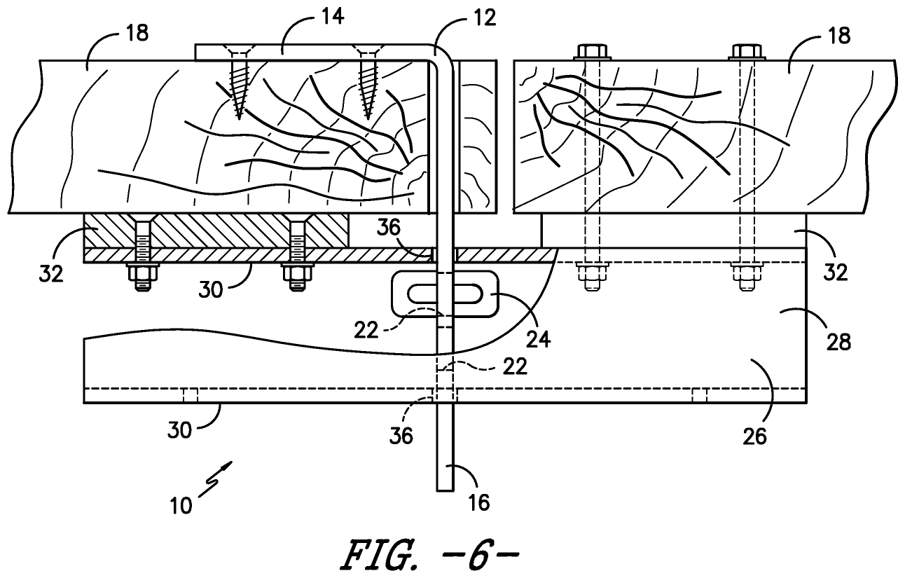

The present locking mechanism 10, in a first embodiment shown in FIGS. 1-9, includes an L-shaped bracket 12 that includes a first side and a second side. The first side 14 preferably includes a pair of holes to receive screws, so that the first side 14 may be screwed, or otherwise attached, to the interior side of a door 18 or door frame 20. The second side 16 of the L-shaped bracket 12 extends through a slot in the door 18 (or a door frame 20) so that it protrudes from the slot in linear fashion outwardly from the exterior side of the door 18. A lock hole 22 is positioned on the second side 16 of the L-shaped bracket 12, and is used to receive a lock 24, such as a combination lock or other type of lock 24 that fits through the lock hole 22.

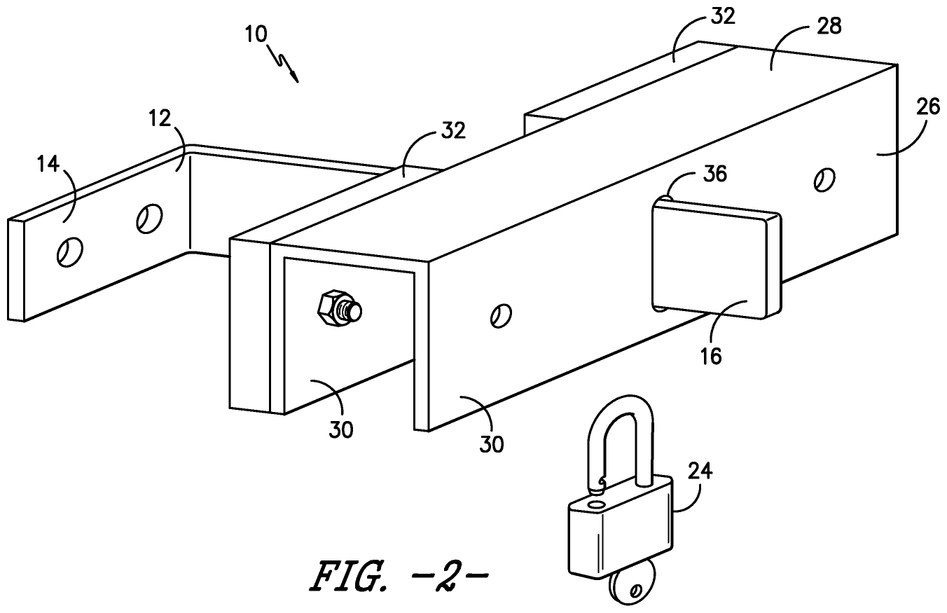

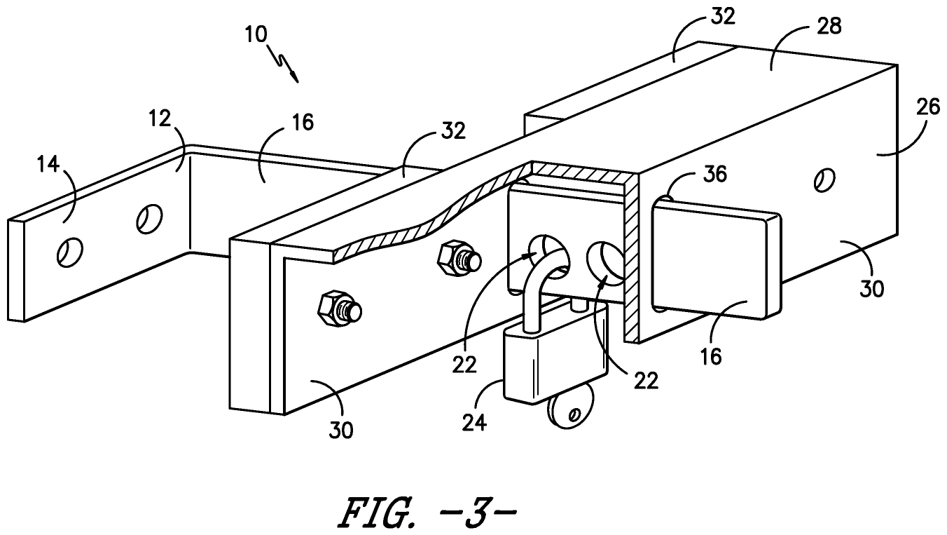

In a preferred embodiment, a three-sided bar 26 has a generally U-shaped cross section, and includes a horizontally oriented top side 28 and a pair of vertically oriented sides 30 that are in parallel relation to one another. Each vertical side 30 is attached to the top side 28 along longitudinal edge thereof, as shown in FIGS. 2 and 3. One of the vertical sides 30 is the front vertical side 30 that faces away from the exterior of the door 18 when in the locked position, and the rear vertical side 30 faces the door 18. A pair of spacer plates 32 may be affixed to the exterior portion of the rear vertical side 30, and the spacer plates 32 are used to provide a snug fit, so that when the bar 26 is in the locked position, the spacer plates 32 are in contact with the exterior faces of each door 18 (one spacer plate 32 is in contact with a first door 18, and the other spacer plate 32 is in contact with a second door 18 of a double door assembly). The spacer plates 32 are screwed or bolted onto the rear vertical side 30 of the bar. It is contemplated that spacer plates 32 of different sizes and thicknesses may be interchangeably used, in order to accommodate different sizes and configurations of double doors 18.

Optionally, the spacer plates 32 may include an adjustable mechanism, or a spring loaded mechanism for achieving a tight fit against the doors. For example, a strip of metal may be bent into an arch and attached to the spacer plate 32 at either end thereof, so that the apex of the arch is pressed against the door when the bar 26 is in the secured position. The metal strip may be rigid enough to apply pressure between the spacer plate and the door, but is also flexible enough to bend slightly out of the relaxed position when such pressure is applied. When the bar 26 is removed from the locked position and the pressure is released, then the metal strip may rebound to its former relaxed state. Alternatively, the metal strip may be oriented in the opposite direction, wherein the apex of the arch is positioned against the spacer plate 32, and the ends of the strip apply pressure to the door 18. Other suitable spring-loaded mechanisms are well known in the art, and may be used instead, as well.

It is contemplated that the present locking mechanism 10 is used in conjunction with another locking mechanism that is commonly found on double doors 18. This locking mechanism includes vertically oriented sliding rods or latches 34 on the distal end of the doors 18 (opposed side from the hinges), wherein the sliding rod 34 at the top of the door 18 may be moved vertically upwardly into a hole in the door frame 20, and wherein the sliding rod 34 at the bottom of the door 18 may be moved vertically downwardly into another hole in the door frame 20, as shown in FIG. 1, which secures one of the doors 18. In this configuration, the L-shaped bracket 12 is preferably affixed to the door having the vertical sliding rods.

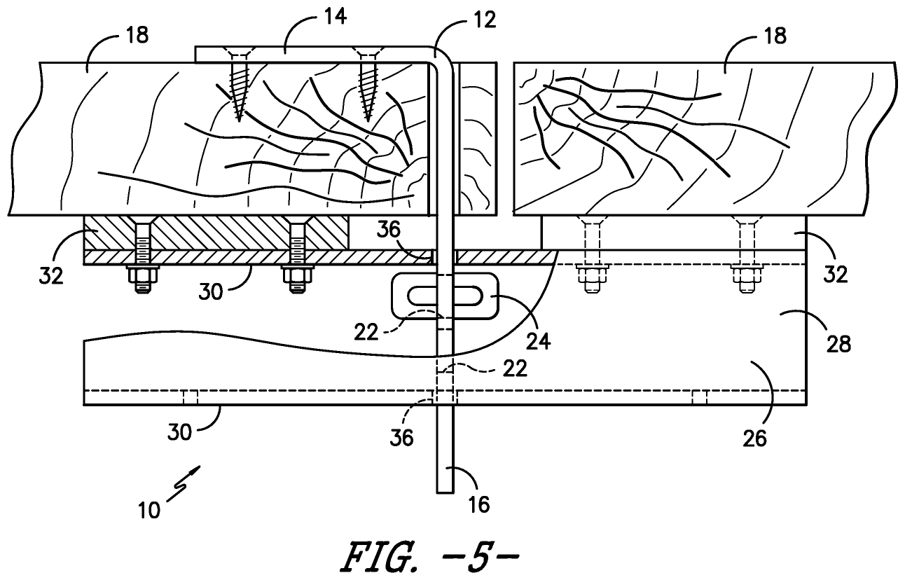

In order to lock the double doors 18 using the locking mechanism 10, a user first closes the doors 18 and uses the vertical sliding rods 34 to secure one of the doors 18. The user then slides the three-sided bar 26 onto the second side 16 of the bracket 12, so that the second side 16 of the bracket 12 extends through both slots 36 in the vertical sides 30 of the bar 26. When the lock hole 22 is positioned between the vertical sides 30 of the bar 26, the user then slides a padlock 24, combination lock, or the like, through the lock hole 22 and secures the lock 24 into the locked position, as shown in FIGS. 3-5. The lock 24 prevents the bar 26 from being removed from the bracket 12, and the bar 26 extends across both doors 18, as shown in FIGS. 1 and 5. In order to unlock the doors 18, the user simply unlocks the lock 24, removes it from the lock hole 22, and removes the bar 26 from the bracket 12, thus allowing the doors 18 to be opened again.

It should be understood that the L-shaped bracket 12 may be positioned so that the second side 16 extends between the double doors 18, rather than extending through a slot in one of the doors 18, in an alternative embodiment. Other slight modifications may be made to the assembly, as well, without departing from the spirit or scope of the invention. For instance, the lock hole 22 may be positioned on the portion of the L-shaped bracket that extends beyond the bar 26, when the bar 26 is in the secured position, rather than between the vertical sides 30. The spacer plates 32 may be optional, and used only when required or desired for a better fit. While certain components and elements may be described herein as being made from a particular material, it should be understood that any suitable material may be used for any of the components, structures and assemblies described herein.

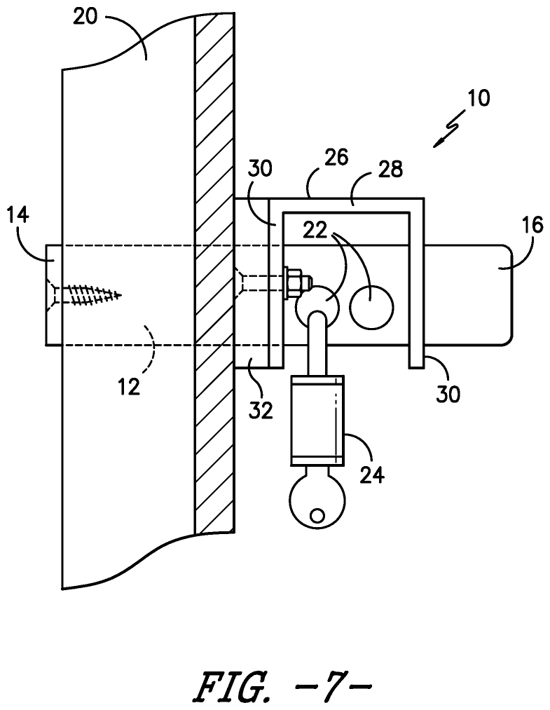

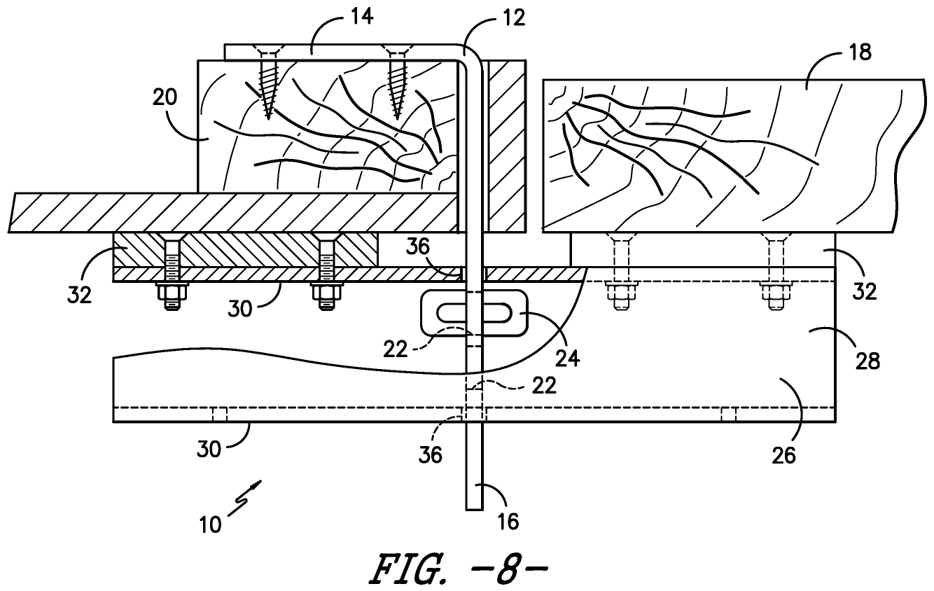

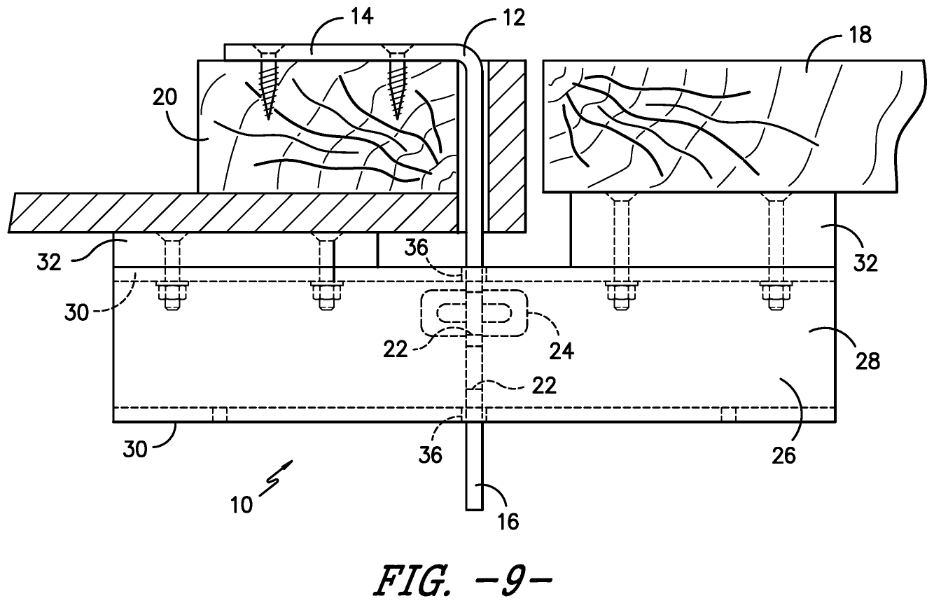

In another embodiment, the present locking mechanism 10 may be used to secure a single door 18, rather than a double door 18. In this embodiment, as shown in FIGS. 1A, 7,8 and 9, the L-shaped bracket 12 is attached to an inner portion of a door frame 20, and extends through a slot to an outer portion of the door frame 20. When the door 18 is closed, the three-sided bar 26 slides onto the second side 16 of the L-shaped bracket 12, as shown in FIGS. 8 and 9, and the lock 24 is placed through the lock hole 22 and locked.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

1. A locking mechanism for doors comprising:
an L-shaped bracket for attachment to a door, including a first section adapted for attachment to an interior side of a door and a second section extending away from said first section at a generally right angle;
a three-sided bar having a horizontally oriented top side with two longitudinal edge and a pair of vertically oriented sides, each said vertical sides extending downwardly from one of said longitudinal edges of said top side;
each said side wall including a slot for receiving said second section of said bracket
said second section of said bracket defining a lock hole for receiving a lock, wherein said lock hole is positioned so that it lies between said vertical sides when said second section of said bracket extends through said slots in said vertical sides of said three-sided bar.

2. The locking mechanism for doors set forth in claim 1, further including at least one spacer plate attached to an exterior portion of one of said vertical sides.

3. The locking mechanism for doors set forth in claim 2, wherein said spacer plate includes a spring loaded mechanism for applying pressure to a door when said second section of said bracket is extending through said slots in said vertical sides of said three-sided bar.

4. The locking mechanism for doors set forth in claim 1, further including a plurality of spacer plates having different thicknesses, wherein said spacer plates may be interchangeably attached to one of said vertical sides of said three-sided bar.

5. The locking mechanism for doors set forth in claim 1, further including a lock for engaging said lock hole.
